(19) United States
(12) Patent Application Publication
(10) Pub. No.: US 2022/0334888 A1
(43) Pub. Date: Oct. 20, 2022

(54) METHODS AND APPARATUS TO SYNCHRONIZE THREADS

(71) Applicant: Intel Corporation, Santa Clara, CA (US)

(72) Inventors: Madhura Chatterjee, Bangalore (IN); Kristoffer Fleming, Chandler, AZ (US); Satyanantha Musunuri, San Ramon, CA (US); Stanley Baran, Chandler, AZ (US); Sangeeta Manepalli, Chandler, AZ (US); Javier Martinez, El Dorado Hills, CA (US)

(21) Appl. No.: 17/855,314

(22) Filed: Jun. 30, 2022

(51) Int. Cl. G06F 9/52; G06F 1/324

(52) U.S. Cl. CPC G06F 9/52; G06F 1/324

(57) ABSTRACT

Methods, apparatus, systems, and articles of manufacture are disclosed to synchronized threads. Example apparatus disclosed herein identify a first trigger frequency associated with a first application thread, the first trigger frequency corresponding to first times of first requests associated with the first application thread. Disclosed example apparatus also identify a second trigger frequency associated with a second application thread, the second trigger frequency corresponding to second times of second requests associated with the second application thread, the second trigger frequency different from the first trigger frequency. Disclosed example apparatus further determine a third trigger frequency based on the first and second trigger frequencies, and adjust at least one of the first requests or the second requests to the third trigger frequency.

### FIELD OF THE DISCLOSURE

This disclosure relates generally to computing devices and, more particularly, to methods and apparatus to synchronize threads.

### BACKGROUND

Computing devices can consume relatively large amounts of energy when executing tasks (e.g., application threads). Power management tools may be deployed to such computing devices to manage energy expenditure and/or extend battery life. Such power management tools may extend battery life by synchronizing tasks.

### BRIEF DESCRIPTION OF THE DRAWINGS

FIG. 1 illustrates an example system constructed in accordance with teachings of this disclosure.

FIG. 2 is a block diagram of example synchronization circuitry included in the system of FIG. 1.

FIG. 3 illustrates an example system that may be used to implement the example system of FIG. 1.

FIG. 4 is an example process flow to synchronize application threads.

FIG. 5 illustrates an example timing sequence that can be implemented by the example synchronization circuitry of FIG. 2.

FIG. 6 is a flowchart representative of example machine readable instructions and/or example operations that may be executed by example processor circuitry to implement the synchronization circuitry of FIG. 2.

FIG. 7 is another flowchart representative of example machine readable instructions and/or example operations that may be executed by example processor circuitry to implement the synchronization circuitry of FIG. 2.

FIG. 8 is a block diagram of an example processing platform including processor circuitry structured to execute the example machine readable instructions and/or the example operations of FIGS. 6 and 7 to implement the synchronization circuitry of FIG. 2.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 6 and 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Today's personal computing devices are expected to deliver real-world user experience of all day battery life, near zero-wait responsiveness, and high levels of performance. Systems (e.g., systems of personal computing devices) have been designed based on satisfying the needs of users of different classes (e.g., gamers, home users, students, etc.). Such systems deliver hardware (HW) and/or software (SW) tradeoffs to achieve different performance goals. For example, systems may include an operating system (OS) to achieve different performance goals during workload execution. However, not all applications use an OS to optimize thread scheduling on a central processing unit (CPU), and there are no global thread synchronization capabilities today that can manage application threads across multiple processing units or xPUs. Thread scheduling policies are policies that assign workloads (e.g., sets of executable instructions referred to herein as threads) to resources (e.g., CPU cores, memory, etc.).

One approach to improve battery life and device performance includes adjusting a clock (e.g., timer, time intervals, etc.) at which a device collects data. However, conventional clock configuration methodologies (e.g., OS timers, network based timers, etc.) are non-systematic, negatively impact the workload execution on the device, and lack generalization and customization capabilities. Therefore, conventional clock scheduling configurations do not achieve sufficient levels of optimization of target systems during workload execution. To address these and/or other limitations, examples disclosed herein determine a synchronized (e.g., synced, common, etc.) trigger frequency (e.g., clock source, clock interval, interval, etc.) to synchronize tasks (e.g., application threads, system settings, application settings, etc.) in the computing device. Examples disclosed herein enable overall power savings and improved user experience across multiple application threads. Examples disclosed herein enable a computing device to delay (e.g., pause) thread execution such that multiple tasks are synchronized to a synced trigger frequency (e.g., timer interval, clock interval, etc.). Examples disclosed herein enable thread synchronization across one or more applications at a platform level.

Examples disclosed herein include processor circuitry to execute the instructions to at least identify a first trigger frequency associated with a first application thread, the first trigger frequency corresponding to first times of first requests sent to the device, identify a second trigger frequency associated with a second application thread, the second trigger frequency corresponding to second times of second requests sent to the device, the second trigger frequency different from the first trigger frequency, determine a third trigger frequency based on the first and second trigger frequencies, and adjust at least one of the first or the second requests to the third trigger frequency.

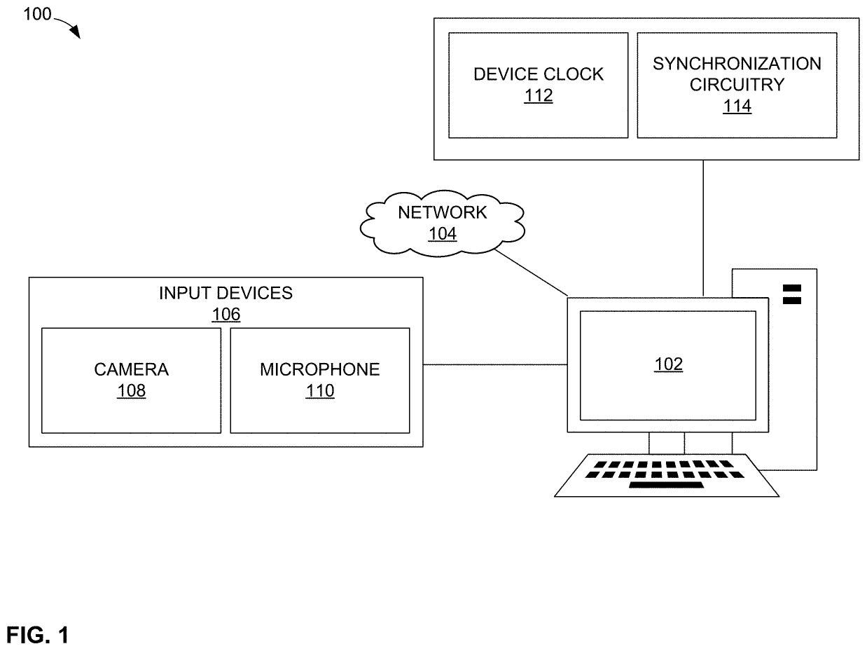

FIG. 1 illustrates an example system 100 constructed in accordance with teachings of this disclosure. The system 100 includes an example electronic device 102, an example network 104, and example input devices 106. The example input devices 106 include an example camera 108 and an example microphone 110. The example electronic device 102, which may also be referred to as the example compute device 102, includes an example device clock 112 and example synchronization circuitry 114.

In this example, the electronic device 102 is implemented as a desktop computer. However, in other examples, the electronic device 102 can be implemented by any other type of electronic device, such as a smartphone, a tablet, a laptop computer, a game console, etc.

In the illustrated example of FIG. 1, the example system 100 includes input devices 106, including a camera 108 and a microphone 110. In some examples, the input devices 106 include any kind of input device such as audio devices, video devices, recording devices, etc. In some examples, the devices 106 include sensors (e.g., Virtual Reality (VR) sensors, gyroscopes, external sensors, motion sensors). In some examples, the input devices 106 include self-driving sensor devices (e.g., radar cameras, lidar cameras, depth cameras, etc.). The devices 106, 108, 110 can by physically connected (e.g., via one or more wires or cables) and/or integral to the device 102. In some examples, the devices 106, 108, 110 are discrete devices that are separate from the electronic device 102. While in this example, the system 100 includes two input devices, the camera 108 and the microphone 110, in other examples, the system 100 can include any number of devices and/or any combination of devices.

The example network 104 can be implemented by any suitable wired and/or wireless network(s) including, for example, one or more data buses, one or more Local Area Networks (LANs), one or more wireless LANS, one or more cellular networks, one or more public networks, etc. The example network 104 enables transmission of data (e.g., audio data) between the devices 102, 106, 108, 110 of the system 100.

In FIG. 1, the electronic device 102 includes the example clock 112 and the example synchronization circuitry 114. In this example, the synchronization circuitry 114 is implemented on the electronic device 102. The example device 102 can include processing units that execute instructions according to a clock rate (e.g., pulses from the clock 112). In some examples, the synchronization circuitry 114 adjusts the trigger frequency (e.g., rate of pulses) of the clock 112. Additionally or alternatively, in some examples, the synchronization circuitry 114 synchronizes pulses (e.g., triggers) associated with application threads of the example devices 106, 108, 110, the clock 112, and/or any other systems (e.g., settings) associated with the device 102. Such settings can include, Wi-Fi bandwidth, audio capture rate, video latency, etc.

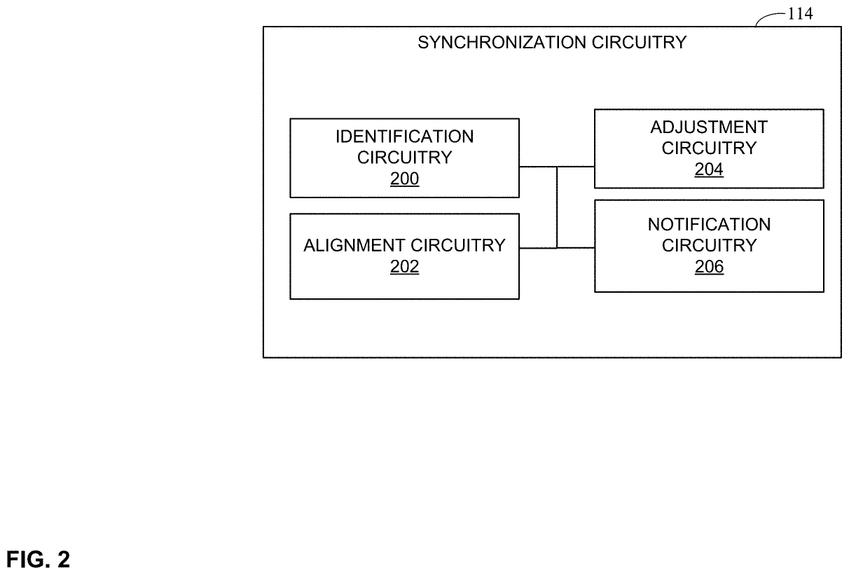

As used herein, “application thread” and/or “thread” refers to a single, independent execution unit that is executed to perform a particular function (e.g., process). For example, a thread may be executed to decode audio data associated with video conferencing software (e.g., Skype, Microsoft Teams, etc.). Additionally or alternatively, another example thread may be executed to record video associated with video conferencing software. In the example of FIG. 1, the example device 102 can run (e.g., execute) video conferencing software such that the example device 102 utilizes the camera 108 and the microphone 110 to execute video conferencing threads (e.g., decode audio, record video, etc.). In turn, the example synchronization circuitry 114 synchronizes the threads associated with software. Examples disclosed herein are described with video conferencing as example software implemented by the example device 102 and/or the example synchronization circuitry 114. However, the example synchronization circuitry 114 and the example system 100 can implement any kind of software utilized by a computing device (e.g., Microsoft Office, self driving cars, etc.). An example implementation of the synchronization circuitry 114 is described below in connection with FIG. 2.

FIG. 2 is a block diagram of the example synchronization circuitry 114 to synchronize multiple application threads associated with a computing device (e.g., the electronic device 102, which may also be referred to as a compute device 102). The example synchronization circuitry 114 of FIGS. 1 and 2 may be instantiated (e.g., creating an instance of, bring into being for any length of time, materialize, implement, etc.) by processor circuitry such as a central processing unit executing instructions. Additionally or alternatively, the synchronization circuitry 114 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIGS. 1 and 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example synchronization circuitry 114 of the example of FIGS. 1 and 2 includes example identification circuitry 200, example alignment circuitry 202, example adjustment circuitry 204, and example notification circuitry 206.

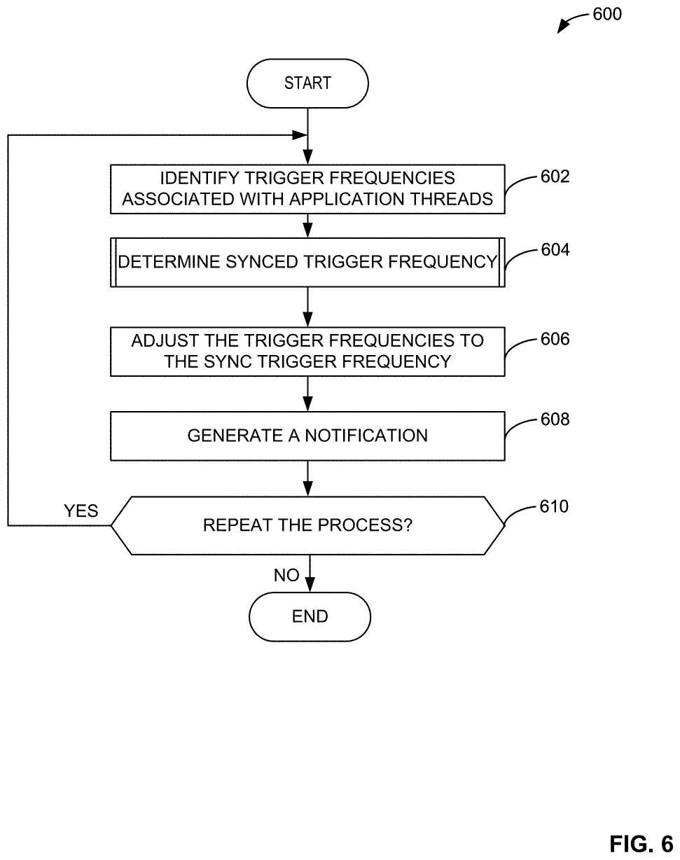

The example identification circuitry 200 identifies trigger frequencies associated with the input devices 106 and/or the compute device 102. In particular, the example identification circuitry 200 identifies trigger frequencies associated with application threads to execute instructions on the devices 102, 106, 108, 110. For example, the identification circuitry 200 identifies a first trigger frequency associated with a first application thread (e.g., decode audio). Further, the identification circuitry 200 identifies a second trigger frequency associated with a second application thread (e.g., record video, display video, etc.). In some examples, the application threads can send requests to the compute device 102, wherein the requests occur at certain times (e.g., time intervals). As such, the example identification circuitry 200 can identify times of the requests sent to the compute device 102. Thus, the identification circuitry 200 identifies trigger frequencies based on times the requests are received at the device. In some examples, the identification circuitry 200 identifies the first trigger frequency to be 5 milliseconds (ms) and the second trigger frequency to be 7 ms. In some examples, the identification circuitry 200 is instantiated by processor circuitry executing identification instructions and/or configured to perform operations such as those represented by the flowcharts of FIGS. 6 and/or 7.

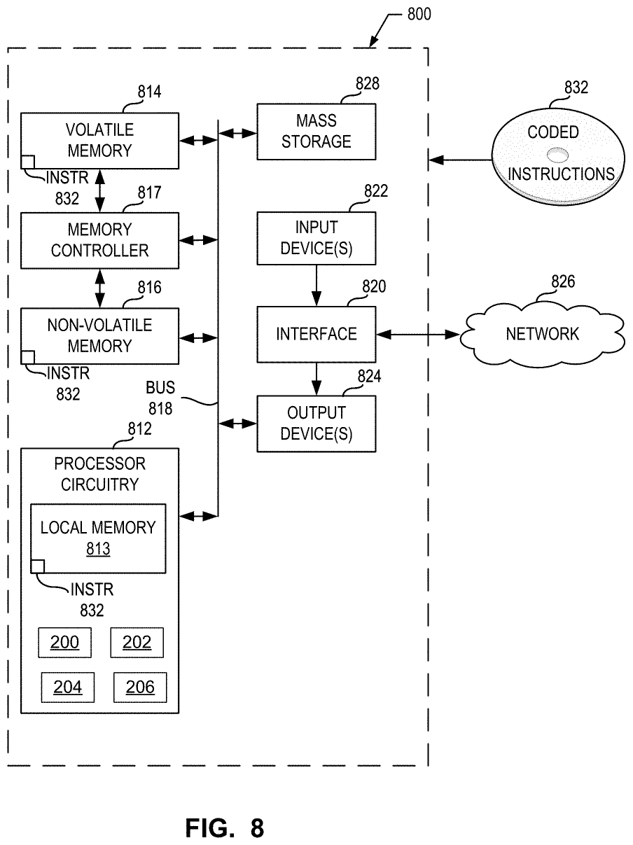

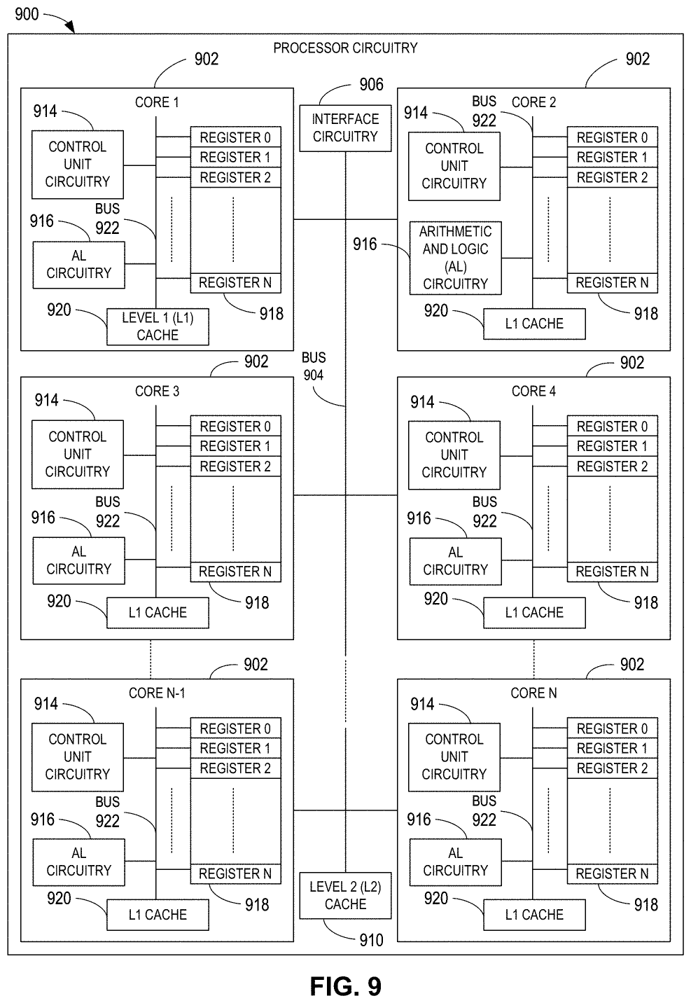

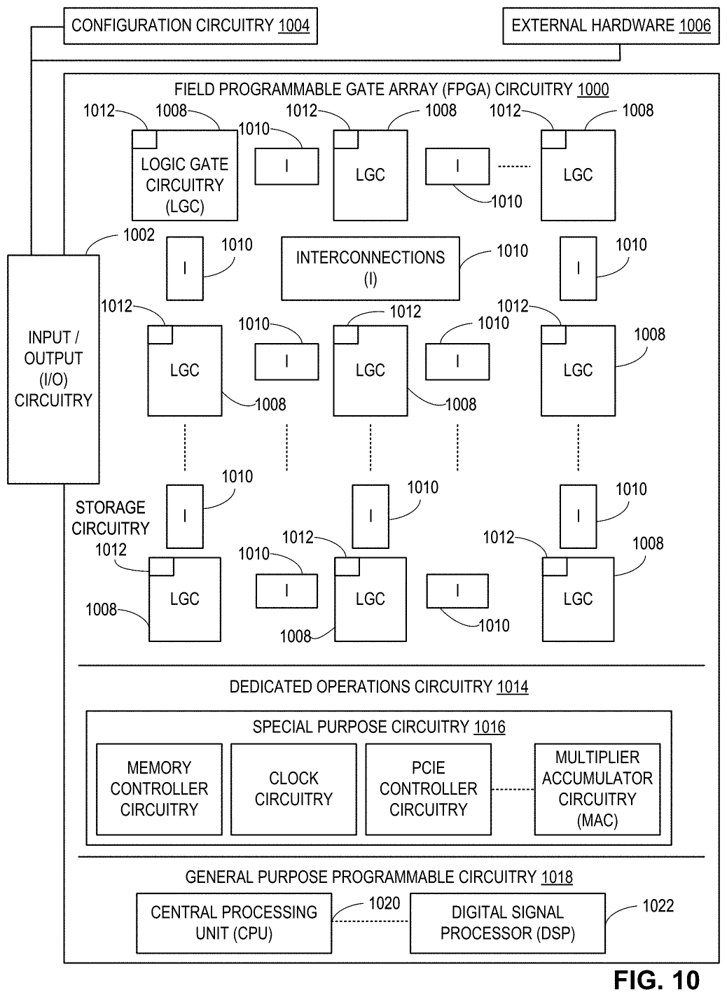

In some examples, the apparatus includes means for identifying trigger frequencies. For example, the means for identifying may be implemented by identification circuitry 200. In some examples, the identification circuitry 200 may be instantiated by processor circuitry such as the example processor circuitry 812 of FIG. 8. For instance, the identification circuitry 200 may be instantiated by the example microprocessor 900 of FIG. 9 executing machine executable instructions such as those implemented by at least blocks 602 and 610 of FIG. 6. In some examples, the identification circuitry 200 may be instantiated by hardware logic circuitry, which may be implemented by an ASIC, XPU, or the FPGA circuitry 1000 of FIG. 10 structured to perform operations corresponding to the machine readable instructions. Additionally or alternatively, the identification circuitry 200 may be instantiated by any other combination of hardware, software, and/or firmware. For example, the identification circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example alignment circuitry 202 determines a third trigger frequency based on the first and second trigger frequencies. For example, the alignment circuitry 202 can determine a synced trigger frequency for the system 100. The example alignment circuitry 202 determines the synced trigger frequency such that the application threads executed by the system 100 (e.g., the devices 102, 106, 108, 110 of the system 100) are aligned to a common trigger frequency. In some examples, the alignment circuitry 202 determines the synced trigger frequency based on a minimum of the first or the second frequency. For example, if the first trigger frequency is 1/(5 ms)=200 Hertz (HZ) (e.g., the inverse of a first trigger period of 5 ms) and the second trigger frequency is 1/(10 ms)=100 Hz (e.g., the inverse of a second trigger period of 5 ms), then the alignment circuitry 202 determines the synced trigger frequency to be 1/(10 ms)=100 Hz. In some examples, the alignment circuitry 202 determines the synced trigger frequency based on a maximum of the first or the second frequency. For example, if the first trigger frequency is 1/(5 ms)=200 Hz and the second trigger frequency is 1/(10 ms)=100 Hz, then the alignment circuitry 202 determines the synced trigger frequency to be 1/(5 ms)=200 Hz. In some examples, the alignment circuitry 202 determines the synced trigger frequency based on an average of the first and the second trigger frequency. For example, if the first trigger frequency is 1/(5 ms)=200 Hz and the second trigger frequency is 1/(10 ms)=100 Hz, then the alignment circuitry 202 determines the synced trigger frequency to be 1/(7.5ms)=133.33 Hz. In some examples, the alignment circuitry 202 determines the synced trigger frequency based on system settings of the device 102, user settings, and/or application settings of the device 102. In some examples, the alignment circuitry 202 is instantiated by processor circuitry executing alignment instructions and/or configured to perform operations such as those represented by the flowcharts of FIG. 6 and/or 7.

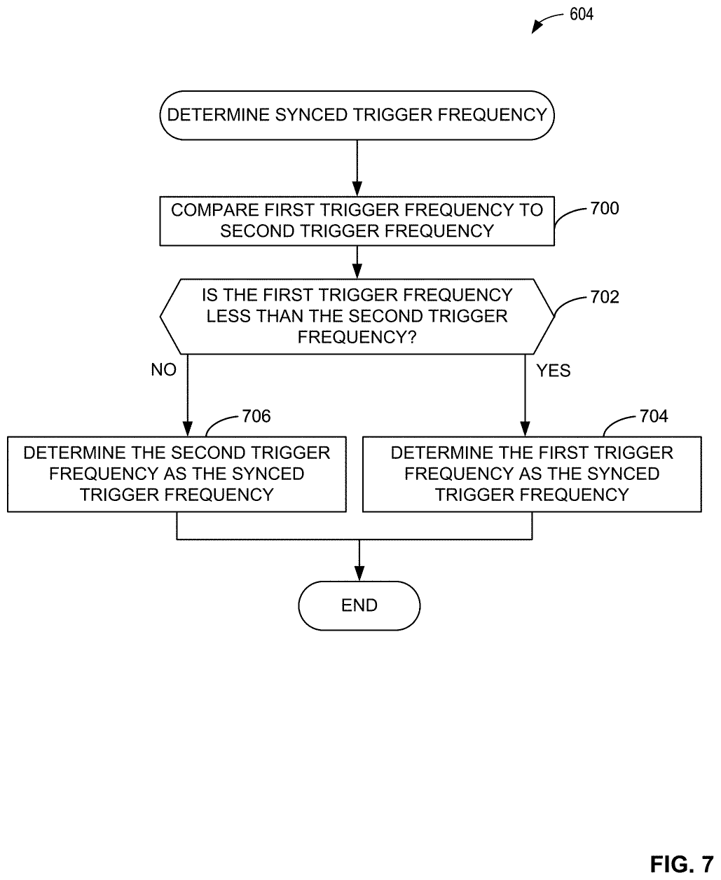

In some examples, the apparatus includes means for determining a synced trigger frequency. For example, the means for determining may be implemented by alignment circuitry 202. In some examples, the alignment circuitry 202 may be instantiated by processor circuitry such as the example processor circuitry 812 of FIG. 8. For instance, the alignment circuitry 202 may be instantiated by the example microprocessor 900 of FIG. 9 executing machine executable instructions such as those implemented by at least blocks 604 and 610 of FIG. 6 and blocks 700, 702, 704, 706 of FIG. 7. In some examples, the alignment circuitry 202 may be instantiated by hardware logic circuitry, which may be implemented by an ASIC, XPU, or the FPGA circuitry 1000 of FIG. 10 structured to perform operations corresponding to the machine readable instructions. Additionally or alternatively, the alignment circuitry 202 may be instantiated by any other combination of hardware, software, and/or firmware. For example, the alignment circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example adjustment circuitry 204 adjusts at least one of the first and the second trigger frequencies to the third trigger frequency. In some examples, the adjustment circuitry 204 can delay (e.g., pause) the second trigger frequency such that the instructions of the second application thread execute according to the synced trigger frequency. For example, if the second trigger frequency is 1/(10 ms)=100 Hz and the synced trigger frequency is 1/(5 ms)=200 Hz, the adjustment circuitry 204 delays the second application thread (e.g., requests corresponding to the second application thread) by time period, such as 5 ms, to cause the second trigger frequency to match (e.g., align with) the synced trigger frequency. In some examples, the adjustment circuitry 204 can adjust the first and the second trigger frequencies based on the synced frequency. For example, if the synced trigger frequency is greater than the first trigger frequency and the second trigger frequency, the adjustment circuitry 204 can delay the first and the second trigger frequencies to align to the synced trigger frequency. In some examples, the adjustment circuitry 204 is instantiated by processor circuitry executing adjustment instructions and/or configured to perform operations such as those represented by the flowcharts of FIG. 6 and/or 7.

In some examples, the apparatus includes means for adjusting trigger frequencies. For example, the means for adjusting may be implemented by adjustment circuitry 204. In some examples, the adjustment circuitry 204 may be instantiated by processor circuitry such as the example processor circuitry 812 of FIG. 8. For instance, the adjustment circuitry 204 may be instantiated by the example microprocessor 900 of FIG. 9 executing machine executable instructions such as those implemented by at least blocks 606 of FIG. 6. In some examples, the adjustment circuitry 204 may be instantiated by hardware logic circuitry, which may be implemented by an ASIC, XPU, or the FPGA circuitry 1000 of FIG. 10 structured to perform operations corresponding to the machine readable instructions. Additionally or alternatively, the adjustment circuitry 204 may be instantiated by any other combination of hardware, software, and/or firmware. For example, the adjustment circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example notification circuitry 206 generates (e.g., sends) a notification to the compute device 102. In some examples, the notification circuitry 206 generates a notification indicating adjustments (e.g., changes) of at least one of the first or the second trigger frequencies. In some examples, the notification circuitry 206 is instantiated by processor circuitry executing notification instructions and/or configured to perform operations such as those represented by the flowcharts of FIG. 6 and/or 7.

In some examples, the apparatus includes means for generating a notification. For example, the means for generating may be implemented by notification circuitry 206. In some examples, the notification circuitry 206 may be instantiated by processor circuitry such as the example processor circuitry 812 of FIG. 8. For instance, the notification circuitry 206 may be instantiated by the example microprocessor 900 of FIG. 9 executing machine executable instructions such as those implemented by at least blocks 608 of FIG. 6. In some examples, the notification circuitry 206 may be instantiated by hardware logic circuitry, which may be implemented by an ASIC, XPU, or the FPGA circuitry 1000 of FIG. 10 structured to perform operations corresponding to the machine readable instructions. Additionally or alternatively, the notification circuitry 206 may be instantiated by any other combination of hardware, software, and/or firmware. For example, the notification circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

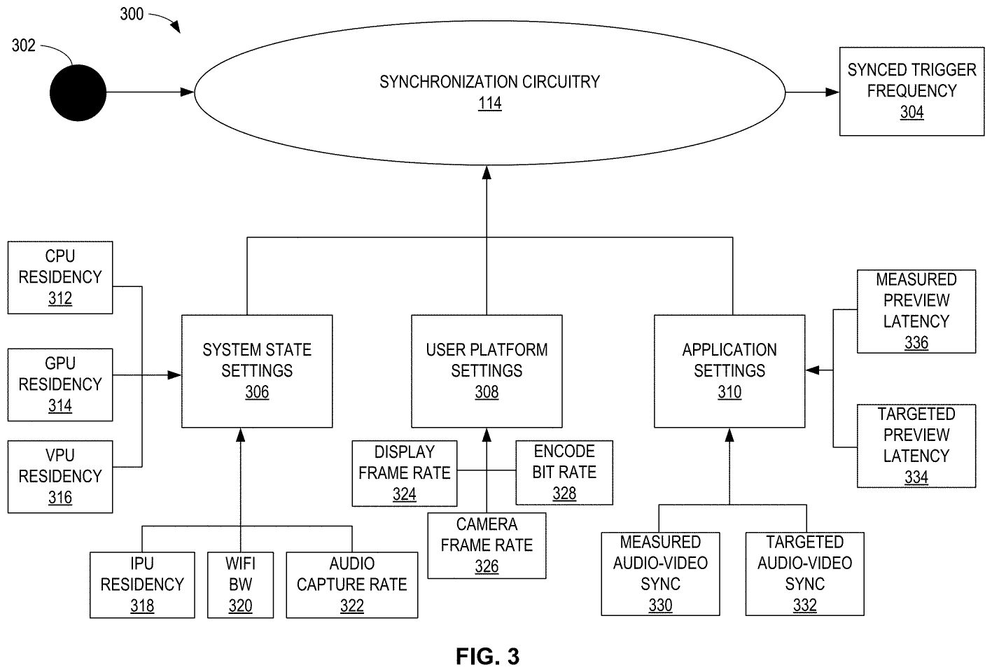

FIG. 3 is an example system 300 that may be used to implement the example system 100 of FIG. 1. The example system 300 begins operation based on an event represented by example node 302. The example system 300 continues to execute the example synchronization circuitry 114, such that the synchronization circuitry 114 outputs a synced trigger frequency 304. In the example of FIG. 3, inputs to the synchronization circuitry 114 include system state settings 306, user platform settings 308, and application settings 310. In some examples, each of the settings 306, 308, 310 include multiple threads that can represent the aforementioned first and second application threads in the system 100.

The example system state settings 306 can include power (e.g., power state, C state, battery life, etc.) data, Wi-Fi data, sensor sampling rate, network transmit rate, and/or audio data associated with the device 102. In this example, the system state settings 308 include central processing unit (CPU) residency 312, graphics processing unit (GPU) residency 314, vision processing unit (VPU) residency 316, infrastructure processing unit (IPU) residency 318, Wi-Fi bandwidth (BW) 320, and audio capture rate 322. As used herein, “residency” refers to a percentage of the power (e.g., battery, energy, etc.) consumed by a processing unit. For example, CPU residency 312 refers to a percentage of the power consumed based on operations of a CPU (e.g., an amount of time the device spent in a power state, waking the device from a sleep state, etc.).

The example user platform settings 308 can include frame rates associated with the devices 102, 106, 108, 110. In this example, the user platform settings 308 can include a display frame rate 324, a camera frame rate 326, and/or an encode bit rate 328. As used herein, “frame rate” refers to a frequency at which frames of video and/or pictures are displayed on a device. For example, the display frame rate 324 can refer to a number of frames-per-second (fps) the display (e.g., the display screen of the device 102) is able to draw a new image. In some examples, the camera frame rate 326 can refer to a frequency at which consecutive images (e.g., frames) are captured by a camera (e.g., the camera 108). As used herein, “bit rate” refers to a number of bits per second that can be conveyed and/or processed per unit of time. For example, the encode bit rate 328 can refer to an amount of data encoded for a unit of time. In some examples, the encode bit rate 328 can refer to video data captured in bits per second (bps) and/or audio data captured in bps.

The example application settings 310 can include user experience settings associated with the device 102. In this example, the application settings 310 include measured audio-video sync 330, targeted audio-video sync 332, targeted preview latency 334, measured preview latency 336. In some examples, the measured audio-video sync 330 and the targeted audio-video sync 332 indicates a lag (e.g., difference) between audio-video data displayed at the device 102. As used herein, “latency” refers to a delay (e.g., time delay) between a request to execute an application thread and the execution of that thread. For example, the measured preview latency 336 can refer to a time delay between a request to play a video on the display of the device 102 and the time the video begins to play on the device 102. In some examples, the system state settings 306 include the measured preview latency 336 and the measured audio-video sync 330

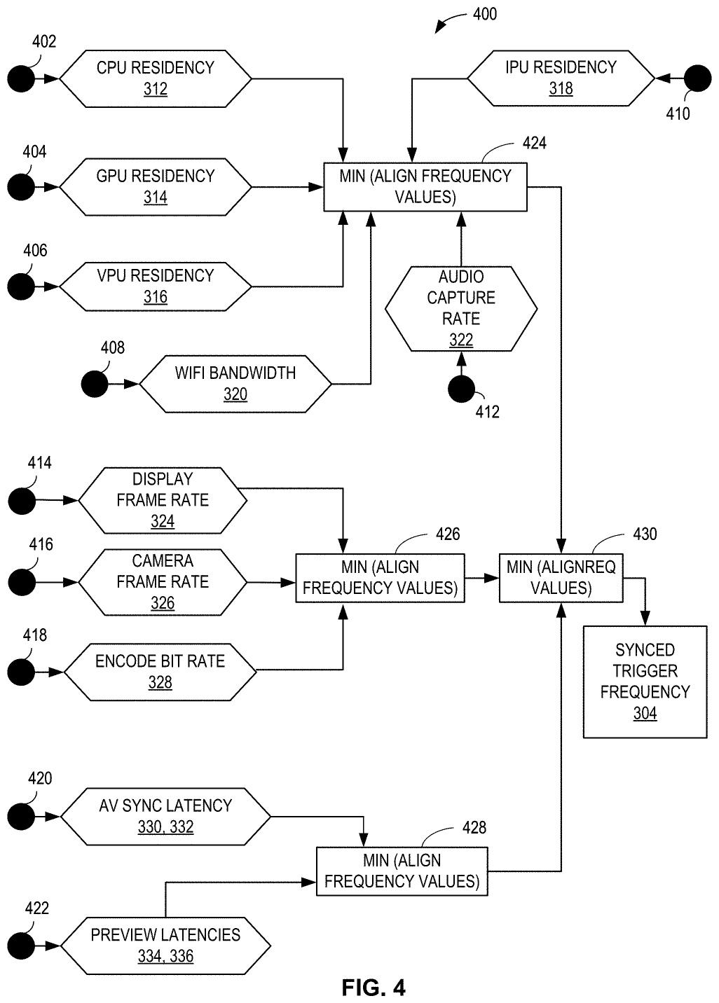

FIG. 4 illustrates an example process flow 400 to determine the synced trigger frequency 304. The example process flow 400 can begin at any of the example nodes 402, 404, 406, 408, 410, 412, 414, 416, 418, 420, 422. In the example of FIG. 4, the example synchronization circuitry 114 determines the synced trigger frequency 304 based on minimum values 424, 426, 428, 430 of the trigger frequencies associated with the application threads for the inputs 312, 314, 316, 318, 320, 322, 324, 326, 328, 330, 332, 334, 336. In some examples, the example synchronization circuitry 114 determines the synced trigger frequency 304 based on a maximum and/or an average of the trigger frequencies associated with the inputs 312, 314, 316, 318, 320, 322, 324, 326, 328, 330, 332, 334, 336.

In some examples, the minimum value 424 includes a minimum trigger frequency based on the inputs 312, 314, 316, 318, 320, 322. For example, the CPU residency 312 trigger frequency can be 1/(15 ms)=66.66 Hz, the GPU residency 314 can be 1/(15 ms)=66.66 Hz, the VPU residency 316 trigger frequency can be 1/(10 ms)=100 Hz, the IPU residency 318 trigger frequency can be 1/(15 ms)=66.66 Hz, the Wi-Fi bandwidth 320 trigger frequency can be 1/(15 ms)=66.66 Hz, and the audio capture rate 322 trigger frequency can be 1/(10 ms)=100 Hz. In such examples, the minimum value 424 is 1/(15 ms), thereby defining a minimum trigger frequency for the inputs 312, 314, 316, 318, 320, 322 (e.g., the system state settings 306) as 1/(15 ms)=66.66 Hz. In some examples, the CPU residency 312 trigger frequency is a percentage based on an active residency of the CPU. In some examples, the GPU residency 314 trigger frequency is a percentage based on an active residency of the GPU. In some examples, the VPU residency 316 trigger frequency is a percentage based on an active residency of the VPU. Further, the IPU residency 318 trigger frequency is a percentage based on an active residency of the IPU.

In some examples, the minimum value 426 includes a minimum trigger frequency based on the inputs 324, 326, 328. For example, the display frame rate 324 can be 1/(20 ms)=50 Hz, the camera frame rate 326 can be 1/(17 ms)=58.82 Hz, and the encode bit rate 328 can be 1/(15 ms)=66.66 Hz. In such examples, the minimum value 426 is 1/(20 ms), thereby defining a minimum trigger frequency for the inputs 324, 326, 328 (e.g., the user platform settings 308) as 1/(20 ms)=50 Hz.

In some examples, the minimum value 428 includes a minimum trigger frequency based on the inputs 330, 332, 334, 336. For example, the audio-video (AV) sync latencies 330, 332 can be 12 ms and the preview latencies 334, 336 can be 12 ms. In such examples, the minimum value 428 is 12 ms, thereby defining a minimum time period for the inputs 330, 332, 334, 336 (e.g., the application settings 310) as 12 ms. In this example, minimum time period of 12 ms can be denoted in the frequency domain as 1/(12 ms)=83.33 Hz.

In FIG. 4, the minimum value 430 represents a minimum value of the values 424, 426, 428. In this example, the minimum value 430 is 1/(20 ms)=50 Hz based on the minimum value 426 being less than the value 428 (e.g., 1/(12 ms)) and less than the value 424 (e.g., 1/(15 ms)). Thus, the minimum value 430 defines the synced trigger frequency 304 as 1/(20 ms).

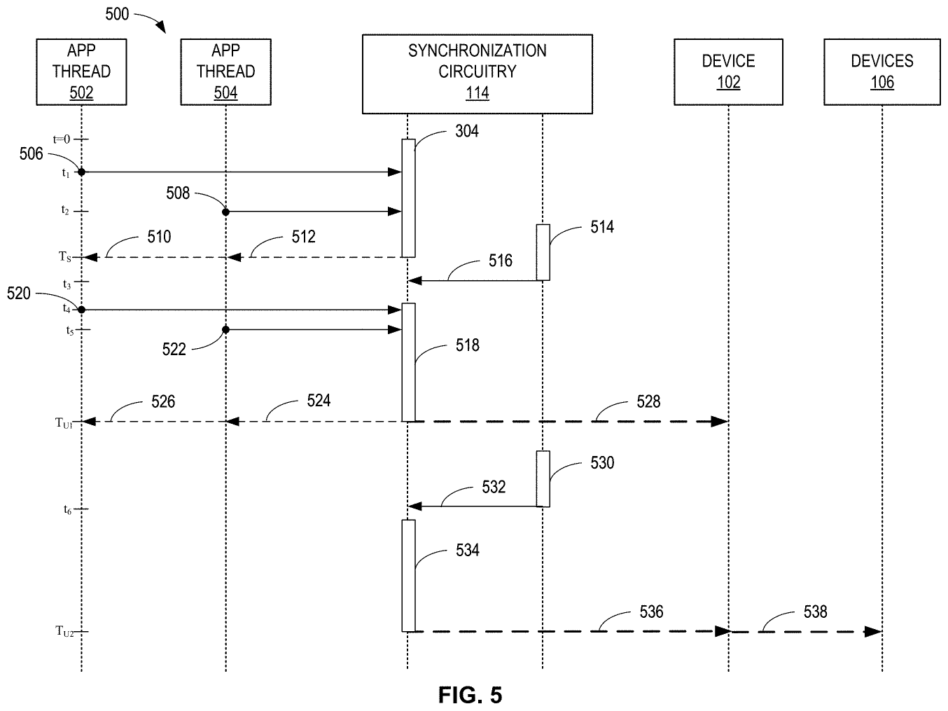

FIG. 5 illustrates an example timing sequence 500 that can be implemented by the example synchronization circuitry 114. The example timing sequence 500 includes a first application thread 502, a second application thread 504, the synchronization circuitry 114, the device 102, and the devices 106. In some examples, the application threads 502, 504 can execute any two of the inputs 312, 314, 316, 318, 320, 322, 324, 326, 328, 330, 332, 334, 336.

In the example time sequence 500, the first application thread 502 (e.g., audio capture rate 322) sends a request 506 at a time t₁ (e.g., record audio at time t₁). In turn, the example identification circuitry 200 identifies the time t₁ corresponding to the request 506. In some examples, the thread 502 includes multiple ones of request 506 such that times of the multiple requests 506 define a first trigger frequency. The second application thread 504 (e.g., camera frame rate 326) sends a request 508 at a time t₂ (e.g., display video at time t₂). In turn, the example identification circuitry 200 identifies the time t₂ corresponding to the request 508. In some examples, the thread 504 includes multiple ones of the request 508 such that times of the multiple ones of the request 508 define a second trigger frequency. In this example, the synced trigger frequency 304 corresponds to a time period Tₛ, wherein the time period Tₛ defines the length of a period of the synced trigger frequency 304 in units of time (e.g., ms). The length of a period of the synced trigger frequency 304 can be a time from t=0 to Tₛ. In some examples, the alignment circuitry 202 determines the synced trigger frequency as described in connection with FIGS. 2, 6, and 7.

In FIG. 5, the request 506 occurs at the time ti, wherein t₁ is less than Tₛ. The request 508 occurs at the time t₂, wherein t₂ is less than Tₛ. Due to t₁ being different from Tₛ and/or to t₂ being different from Tₛ, the adjustment circuitry 204 delays at least one of the requests 506, 508 to align to the synced trigger frequency 304 (e.g., to align with the period of the synced trigger frequency 304). Accordingly, the requests 506, 508 execute the instructions of the threads 502, 504 at substantially (e.g., within 2 ms or some other tolerance) the same time. As shown in FIG. 5, the thread 502 executes instructions at the time Tₛ as indicated by arrow 510, and the thread 504 executes instructions at the time Tₛ as indicated by arrow 512. For example, if t₁=4 ms, t₂=7 ms, and Tₛ=10 ms, then the request 506 can be paused for 6 ms to align with Tₛ and the request 508 can be paused for 3 ms to align with Tₛ. In some examples, the adjustment circuitry 204 can pause the requests 506, 508 to align with Tₛ.

In the example of FIG. 5, the synchronization circuitry 114 can calculate (e.g., recalculate, update, generate, etc.) the synced trigger frequency 304, as shown at block 514. In some examples, the synced trigger frequency 304 is not updated. However, in this example, the synchronization circuitry 114 changes the synced trigger frequency 304 based on times of the requests 506, 508, as described in detail in connection with FIGS. 2, 6, and 7. The synchronization circuitry 114 adjusts the synced trigger frequency 304 at a time t₃ (e.g., 11 ms) as indicated by arrow 516. In this example, the synchronization circuitry 114 changes the synced trigger frequency 304 to a first updated trigger frequency 518. The first updated trigger frequency 518 corresponds to a time period T_{U1}. In some examples, T_{U1} is 12 ms.

In this example, the thread 502 also sends a request 520. In turn, the example identification circuitry 200 identifies a time t₄ corresponding to the request 520. Additionally or alternatively, the thread 504 sends a request 522. In turn, the example identification circuitry 200 identifies a time t5 corresponding to the request 522. In this example, the adjustment circuitry 204 delays the requests 520, 522 to align to the first updated trigger frequency 518. Thus, the requests 520, 522 execute the instructions of the threads 502, 504 at substantially the same time. As shown in FIG. 5, the thread 504 executes instructions at the time T_{U1} as indicated by arrow 524, and the thread 502 executes instructions at the time T_{U1} as indicated by arrow 526. For example, if t₄=15 ms, t₅=16 ms, and T_{U1}=25 ms then the request 520 can be paused for 10 ms to align with T_{U1} and the request 522 can be paused for 9 ms to align with T_{U1}. In some examples, the adjustment circuitry 204 can pause the requests 520, 522 to align with T_{U1}.

The example timing sequence 500 includes a first notification 528. The example notification circuitry 206 generates the first notification 528 to send to the device 102. In this example, the notification circuitry 206 sends the first notification 528 in response to a change in the synced trigger frequency 304 (e.g., changing the synced trigger frequency 304 to the first updated trigger frequency 518). In some examples, the first notification 528 includes data (e.g., information, time data, etc.) indicating the change in the sync trigger frequency 304 and/or data pertaining to the first updated trigger frequency 518. In some examples, the notification circuitry 206 sends the first notification 528 to each of the devices 102, 106.

The example timing sequence 500 further includes another change in the sync trigger frequency 304 and/or the first updated trigger frequency 518 (as shown at block 530). For example, the synchronization circuitry 114 can change the first updated trigger frequency 518 based on times of the requests 520, 522, as described in detail in connection with FIGS. 2, 6, and 7. The synchronization circuitry 114 adjusts the first updated trigger frequency 518 at a time t6 (e.g., 27 ms) as indicated by arrow 532. In this example, the synchronization circuitry 114 changes the first updated trigger frequency 518 to a second updated trigger frequency 534. The second updated trigger frequency 534 corresponds a time period T_{U2}. In some examples, T_{U2} is 41 ms.

The example timing sequence 500 includes a second notification 536 and a third notification 538. The example notification circuitry 206 generates the second notification 536 to send to the device 102 and the third notification 538 to send to the devices 106. In this example, the notification circuitry 206 sends the second notification 536 in response to a change in the first updated trigger frequency 518 (e.g., changing the first updated trigger frequency 518 to the second updated trigger frequency 534). In some examples, the notifications 536, 538 include data (e.g., information, time data, etc.) indicating the change in the first updated trigger frequency 518 and/or data pertaining to the second updated trigger frequency 534. In some examples, the synchronization circuitry 114 utilizes the second updated trigger frequency 534 to sync subsequent requests associated with the threads 502, 504.

While an example manner of implementing the synchronization circuitry 114 of FIG. 1 is illustrated in FIG. 2, one or more of the elements, processes, and/or devices illustrated in FIG. 2 may be combined, divided, re-arranged, omitted, eliminated, and/or implemented in any other way. Further, the example identification circuitry 200, the example alignment circuitry 202, the example adjustment circuitry 204, the example notification circuitry 206, and/or, more generally, the example synchronization circuitry 114 of FIG. 1, may be implemented by hardware alone or by hardware in combination with software and/or firmware. Thus, for example, any of the example identification circuitry 200, the example alignment circuitry 202, the example adjustment circuitry 204, the example notification circuitry 206, and/or, more generally, the example synchronization circuitry 114, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example synchronization circuitry 114 of FIGS. 1 and 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the synchronization circuitry 114 of FIGS. 1 and 2, is shown in FIGS. 6 and 7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6 and 7, many other methods of implementing the example synchronization circuitry 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to synchronize threads. The machine readable instructions and/or the operations 600 of FIG. 6 begin at block 602, at which the identification circuitry 200 identifies trigger frequencies associated with application threads. In some examples, the identification circuitry 200 identifies trigger frequencies of requests to threads associated with at least two of the inputs 312, 314, 316, 318, 320, 322, 324, 326, 328, 330, 332, 334, 336. In some examples, the identification circuitry 200 identifies the times (e.g., t₁, t₂, t₄, t₅, etc.) corresponding to requests (e.g., the requests 506, 508, 520, 522) associated with the application threads 502, 504. In some examples, the identification circuitry 200 identifies the trigger frequencies 304, 518, 534, etc. In some examples, the identification circuitry 200 identifies trigger frequencies based on times the requests are received at the device 102 and/or the devices 106.

At block 604, the example alignment circuitry 202 determines the synced trigger frequency 304 (e.g., trigger frequencies 518, 534, etc.), which is further described in connection with FIG. 7.

At block 606, the example adjustment circuitry 204 adjusts at least one of the first or the second trigger frequencies to the synced trigger frequency 304. For example, the example adjustment circuitry 204 adjusts the request 506 (e.g., multiple ones of the request 506) to align to the synced trigger frequency 304 and adjusts the request 508 (e.g., multiple ones of the request 508) to align to the synced trigger frequency 304. In some examples, the adjustment circuitry 204 delays the request 506 and/or the request 508 to align to the synced trigger frequency 304. For example, if the request occurs or is otherwise associated with a time t₁=4 ms and the synced trigger frequency 304 is associated with a period with a next transition at Tₛ=10 ms, then the adjustment circuitry 204 can pause the request 506 for 6 ms to align with Tₛ. Additionally or alternatively, if the request occurs or is otherwise associated with a time t₂=7 ms and the synced trigger frequency 304 is associated with a period with a next transition at Tₛ=10, then the adjustment circuitry 204 can pause the request 508 for 3 ms to align with Tₛ.

At block 608, the example notification circuitry 206 generates a notification (e.g., the notifications 528, 536, 538, etc.) to send to the devices (e.g., the devices 102, 106, etc.). In some examples, the notification circuitry 206 generates the first notification 528 to send to the device 102. In particular, the notification circuitry 206 sends the first notification 528 in response to a change in the synced trigger frequency 304. In some examples, the first notification 528 includes data (e.g., information, time data, etc.) indicating the change in the sync trigger frequency 304 and/or data pertaining to the first updated trigger frequency 518. In some examples, the notification circuitry 206 generates the second notification 536 to send to the device 102 and the third notification 538 to send to the devices 106. In particular, the notification circuitry 206 sends the second notification 536 in response to a change in the first updated trigger frequency 518. In some examples, the notifications 536, 538 include data (e.g., information, time data, etc.) indicating the change in the first updated trigger frequency 518 and/or data pertaining to the second updated trigger frequency 534.

At block 610, the identification circuitry 200 and/or the alignment circuitry 202 determines whether to repeat the process. If the process is to be repeated (block 610), the process returns to block 602. Otherwise the process ends.

FIG. 7 is a flowchart representative of example machine readable instructions and/or example operations that may be executed and/or instantiated by processor circuitry to implement the example alignment circuitry 202, as described above in connection with block 604 of FIG. 6. The machine readable instructions and/or the operations of FIG. 7 begin at block 700, at which the example alignment circuitry 202 compares a first trigger frequency to a second trigger frequency. In some examples, the thread 502 includes multiple ones of the request 506 such that times of the multiple requests 506 define a first trigger frequency. In some examples, the thread 504 includes multiple ones of the request 508 such that times of the multiple ones of the request 508 define a second trigger frequency. Thus, the example alignment circuitry 202 compares the first trigger frequency associated with the thread 502 to the second trigger frequency associated with the thread 504.

At block 702, the example alignment circuitry 202 determines whether the first trigger frequency is less than the second trigger frequency. In some examples, the first trigger frequency associated with the thread 502 is 1/(12 ms)=83.33 Hz and the second trigger frequency associated with the thread 504 is 1/(15 ms)=66.66 Hz. In some examples, the first trigger frequency associated with the thread 502 is 1/(15 ms)=66.66 Hz and the second trigger frequency associated with the thread 504 is 1/(12 ms)=83.33 Hz. If the first trigger frequency is less than the second trigger frequency (block 702), control of the process proceeds to block 704. Otherwise, the process proceeds to block 706.

At block 704, the example alignment circuitry 202 determines the first trigger frequency (e.g., 1/(15 ms)=66.66 Hz) as the synced trigger frequency 304. Then, the process ends.

At block 706, the example alignment circuitry 202 determines the second trigger frequency (e.g., 1/(15 ms)=66.66 Hz) as the synced trigger frequency 304. Then, the process ends.

FIG. 8 is a block diagram of an example processor platform 800 structured to execute and/or instantiate the machine readable instructions and/or the operations of FIGS. 6 and 7 to implement the synchronization circuitry 114 of FIGS. 1 and 2. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example synchronization circuitry 114, the example identification circuitry 200, the example alignment circuitry 202, the example adjustment circuitry 204, and the example notification circuitry 206.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 832, which may be implemented by the machine readable instructions of FIGS. 6 and7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowcharts of FIGS. 6 and 7 to effectively instantiate the synchronization circuitry 114 of FIG. 2 as logic circuits to perform the operations corresponding to those machine readable instructions. in some such examples, the synchronization circuitry 114 of FIG. 2 is instantiated by the hardware circuits of the microprocessor 900 in combination with the instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6 and 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an Ll instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 5. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 6 and 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 6 and 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 6 and 7. As such, the FPGA circuitry 1000 may be structured to effectively instantiate some or all of the machine readable instructions of the flowcharts of FIGS. 6 and 7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 6 and 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may be implemented by external hardware circuitry. For example, the external hardware 1006 may be implemented by the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations that may correspond to at least some of the machine readable instructions of FIGS. 6 and 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 6 and 7 may be executed by one or more of the cores 902 of FIG. 9, a second portion of the machine readable instructions represented by the flowcharts of FIGS. 6 and 7 may be executed by the FPGA circuitry 1000 of FIG. 10, and/or a third portion of the machine readable instructions represented by the flowcharts of FIGS. 6 and 7 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

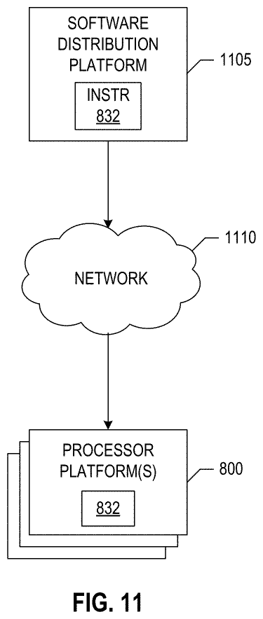

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6 and 7, as described above. The one or more servers of the example software distribution platform 1105 are in communication with an example network 1110, which may correspond to any one or more of the Internet and/or any of the example networks 104, 1110 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6 and 7, may be downloaded to the example processor platform 800, which is to execute the machine readable instructions 832 to implement the operations of FIGS. 6 and 7. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that determine a synchronized trigger frequency to synchronize tasks in a computing device. Examples disclosed herein enable overall power savings and improved user experience across multiple application threads. Examples disclosed herein enable a computing device to delay thread execution such that multiple tasks are synchronized to a synced trigger frequency. Disclosed systems, methods, apparatus, and articles of manufacture improve the efficiency of using a computing device by improving battery life and/or optimizing power consumption. Disclosed systems, methods, apparatus, and articles of manufacture are accordingly directed to one or more improvement(s) in the operation of a machine such as a computer or other electronic and/or mechanical device.

Example 1 includes an apparatus to generate a synchronized trigger frequency for a device, the apparatus comprising at least one memory, machine readable instructions, and processor circuitry to at least one of instantiate or execute the machine readable instructions to identify a first trigger frequency associated with a first application thread, the first trigger frequency corresponding to first times of first requests associated with the first application thread, identify a second trigger frequency associated with a second application thread, the second trigger frequency corresponding to second times of second requests associated with the second application thread, the second trigger frequency different from the first trigger frequency, determine a third trigger frequency based on the first and second trigger frequencies, and adjust at least one of the first requests or the second requests to the third trigger frequency.

Example 2 includes the apparatus of example 1, wherein at least one of the first trigger frequency or the second trigger frequency is associated with a user platform setting, the user platform setting including at least one of a display frame rate, a camera frame rate, or an encode bit rate.

Example 3 includes the apparatus of example 1, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

Example 4 includes the apparatus of example 1, wherein at least one of the first trigger frequency or the second trigger frequency is associated with an application setting, the application setting including at least one of measured preview latency, targeted preview latency, measured audio/video sync, or targeted audio/video sync.

Example 5 includes the apparatus of example 1, wherein the processor circuitry is to determine the third trigger frequency based on a minimum of the first trigger frequency and the second trigger frequency.

Example 6 includes the apparatus of example 1, wherein the processor circuitry is to determine the third trigger frequency based on a maximum of the first trigger frequency and the second trigger frequency.

Example 7 includes the apparatus of example 1, wherein the processor circuitry is to determine the third trigger frequency based on an average of the first trigger frequency and the second trigger frequency.

Example 8 includes the apparatus of example 1, wherein the processor circuitry is to adjust the at least one of the first requests or the second requests by delaying processing of the at least one of the first requests or the second requests by the device.

Example 9 includes the apparatus of example 1, wherein the processor circuitry is to generate a notification, the notification to identify an adjustment of at least one of the first trigger frequency or the second trigger frequency.

Example 10 includes At least one non-transitory computer readable medium comprising instructions that, when executed, cause processor circuitry to at least identify a first trigger frequency associated with a first application thread, the first trigger frequency corresponding to first times of first requests associated with the first application thread, identify a second trigger frequency associated with a second application thread, the second trigger frequency corresponding to second times of second requests associated with the second application thread, the second trigger frequency different from the first trigger frequency, determine a third trigger frequency based on the first and second trigger frequencies, and adjust at least one of the first requests or the second requests to the third trigger frequency.

Example 11 includes the at least one non-transitory computer readable medium of example 10, wherein at least one of the first trigger frequency or the second trigger frequency is associated with a user platform setting, the user platform setting including at least one of a display frame rate, a camera frame rate, or an encode bit rate.

Example 12 includes the at least one non-transitory computer readable medium of example 10, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

Example 13 includes the at least one non-transitory computer readable medium of example 10, wherein at least one of the first trigger frequency or the second trigger frequency is associated with an application setting, the application setting including at least one of measured preview latency, targeted preview latency, measured audio/video sync, or targeted audio/video sync.

Example 14 includes the at least one non-transitory computer readable medium of example 10, wherein the instructions cause the processor circuitry to determine the third trigger frequency based on a minimum of the first trigger frequency and the second trigger frequency.

Example 15 includes the at least one non-transitory computer readable medium of example 10, wherein the instructions cause the processor circuitry to determine the third trigger frequency based on a maximum of the first trigger frequency and the second trigger frequency.

Example 16 includes the at least one non-transitory computer readable medium of example 10, wherein the instructions cause the processor circuitry to determine the third trigger frequency based on an average of the first trigger frequency and the second trigger frequency.

Example 17 includes the at least one non-transitory computer readable medium of example 10, wherein the instructions cause the processor circuitry to adjust the at least one of the first requests or the second requests by delaying processing of the at least one of the first requests or the second requests.

Example 18 includes the at least one non-transitory computer readable medium of example 10, wherein the instructions cause the processor circuitry to generate a notification, the notification to identify an adjustment of at least one of the first trigger frequency or the second trigger frequency.

Example 19 includes an apparatus comprising means for identifying trigger frequencies, the means for identifying to identify a first trigger frequency associated with a first application thread, the first trigger frequency corresponding to first times of first requests associated with the first application thread, identify a second trigger frequency associated with a second application thread, the second trigger frequency corresponding to second times of second requests associated with the second application thread, the second trigger frequency different from the first trigger frequency, means for determining a third trigger frequency based on the first and second trigger frequencies, and means for adjusting at least one of the first requests or the second requests to the third trigger frequency.

Example 20 includes the apparatus of example 19, wherein at least one of the first trigger frequency or the second trigger frequency is associated with a user platform setting, the user platform setting including at least one of a display frame rate, a camera frame rate, or an encode bit rate.

Example 21 includes the apparatus of example 19, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

Example 22 includes the apparatus of example 19, wherein at least one of the first trigger frequency or the second trigger frequency is associated with an application setting, the application setting including at least one of measured preview latency, targeted preview latency, measured audio/video sync, or targeted audio/video sync.

Example 23 includes the apparatus of example 19, wherein the means for determining is to determine the third trigger frequency based on a minimum of the first trigger frequency and the second trigger frequency.

Example 24 includes the apparatus of example 19, wherein the means for determining is to determine the third trigger frequency based on a maximum of the first trigger frequency and the second trigger frequency.

Example 25 includes the apparatus of example 19, wherein the means for determining is to determine the third trigger frequency based on an average of the first trigger frequency and the second trigger frequency.

Example 26 includes the apparatus of example 19, wherein the means for adjusting is to adjust the at least one of the first requests or the second requests by delaying processing of the at least one of the first requests or the second requests.

Example 27 includes the apparatus of example 19, further including means for generating a notification, the notification to identify an adjustment of at least one of the first trigger frequency or the second trigger frequency.

Example 28 includes a method comprising identifying a first trigger frequency associated with a first application thread, the first trigger frequency corresponding to first times of first requests associated with the first application thread, identifying a second trigger frequency associated with a second application thread, the second trigger frequency corresponding to second times of second requests associated with the second application thread, the second trigger frequency different from the first trigger frequency, determining a third trigger frequency based on the first and second trigger frequencies, and adjusting at least one of the first requests or the second requests to the third trigger frequency.

Example 29 includes the method of example 28, wherein at least one of the first trigger frequency or the second trigger frequency is associated with a user platform setting, the user platform setting including at least one of a display frame rate, a camera frame rate, or an encode bit rate.

Example 30 includes the method of example 28, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

Example 31 includes the method of example 28, wherein at least one of the first trigger frequency or second trigger frequency is associated with an application setting, the application setting including at least one of measured preview latency, targeted preview latency, measured audio/video sync, or targeted audio/video sync.

Example 32 includes the method of example 28, further including determining the third trigger frequency based on a minimum of the first trigger frequency and the second trigger frequency.

Example 33 includes the method of example 28, further including determining the third trigger frequency based on a maximum of the first trigger frequency and the second trigger frequency.

Example 34 includes the method of example 28, further including determining the third trigger frequency based on an average of the first trigger frequency and the second trigger frequency.

Example 35 includes the method of example 28, further including adjusting the at least one of the first requests or the second requests by delaying processing of the at least one of the first requests or the second requests.

Example 36 includes the method of example 28, further including generating a notification, the notification to identify an adjustment of at least one of the first trigger frequency or the second trigger frequency.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to generate a synchronized trigger frequency for a device, the apparatus comprising:
at least one memory;
machine readable instructions; and
processor circuitry to at least one of instantiate or execute the machine readable instructions to:
identify a first trigger frequency associated with a first application thread, the first trigger frequency corresponding to first times of first requests associated with the first application thread;
identify a second trigger frequency associated with a second application thread, the second trigger frequency corresponding to second times of second requests associated with the second application thread, the second trigger frequency different from the first trigger frequency;
determine a third trigger frequency based on the first and second trigger frequencies; and
adjust at least one of the first requests or the second requests to the third trigger frequency.

2. The apparatus of claim 1, wherein at least one of the first trigger frequency or the second trigger frequency is associated with a user platform setting, the user platform setting including at least one of a display frame rate, a camera frame rate, or an encode bit rate.

3. The apparatus of claim 1, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

4. The apparatus of claim 1, wherein at least one of the first trigger frequency or the second trigger frequency is associated with an application setting, the application setting including at least one of measured preview latency, targeted preview latency, measured audio/video sync, or targeted audio/video sync.

5. The apparatus of claim 1, wherein the processor circuitry is to determine the third trigger frequency based on a minimum of the first trigger frequency and the second trigger frequency.

6. The apparatus of claim 1, wherein the processor circuitry is to determine the third trigger frequency based on a maximum of the first trigger frequency and the second trigger frequency.

7. The apparatus of claim 1, wherein the processor circuitry is to determine the third trigger frequency based on an average of the first trigger frequency and the second trigger frequency.

8. The apparatus of claim 1, wherein the processor circuitry is to adjust the at least one of the first requests or the second requests by delaying processing of the at least one of the first requests or the second requests by the device.

9. The apparatus of claim 1, wherein the processor circuitry is to generate a notification, the notification to identify an adjustment of at least one of the first trigger frequency or the second trigger frequency.

10. At least one non-transitory computer readable medium comprising instructions that, when executed, cause processor circuitry to at least:
identify a first trigger frequency associated with a first application thread, the first trigger frequency corresponding to first times of first requests associated with the first application thread;
identify a second trigger frequency associated with a second application thread, the second trigger frequency corresponding to second times of second requests associated with the second application thread, the second trigger frequency different from the first trigger frequency;
determine a third trigger frequency based on the first and second trigger frequencies; and
adjust at least one of the first requests or the second requests to the third trigger frequency.

11. The at least one non-transitory computer readable medium of claim 10, wherein at least one of the first trigger frequency or the second trigger frequency is associated with a user platform setting, the user platform setting including at least one of a display frame rate, a camera frame rate, or an encode bit rate.

12. The at least one non-transitory computer readable medium of claim 10, wherein at least one of the first trigger frequency or the second trigger frequency is associated with a system state setting, the system state setting including at least one of central processing unit (CPU) bandwidth, graphics processing unit (GPU) bandwidth, vision processing unit (VPU) bandwidth, infrastructure processing unit (IPU) bandwidth, Wi-Fi bandwidth, or an audio capture rate.

13. The at least one non-transitory computer readable medium of claim 10, wherein at least one of the first trigger frequency or the second trigger frequency is associated with an application setting, the application setting including at least one of measured preview latency, targeted preview latency, measured audio/video sync, or targeted audio/video sync.

14. The at least one non-transitory computer readable medium of claim 10, wherein the instructions cause the processor circuitry to determine the third trigger frequency based on a minimum of the first trigger frequency and the second trigger frequency.

15. The at least one non-transitory computer readable medium of claim 10, wherein the instructions cause the processor circuitry to determine the third trigger frequency based on a maximum of the first trigger frequency and the second trigger frequency.

16. The at least one non-transitory computer readable medium of claim 10, wherein the instructions cause the processor circuitry to determine the third trigger frequency based on an average of the first trigger frequency and the second trigger frequency.

17. The at least one non-transitory computer readable medium of claim 10, wherein the instructions cause the processor circuitry to adjust the at least one of the first requests or the second requests by delaying processing of the at least one of the first requests or the second requests.

18. The at least one non-transitory computer readable medium of claim 10, wherein the instructions cause the processor circuitry to generate a notification, the notification to identify an adjustment of at least one of the first trigger frequency or the second trigger frequency.

19. An apparatus comprising:
means for identifying trigger frequencies, the means for identifying to:
identify a first trigger frequency associated with a first application thread, the first trigger frequency corresponding to first times of first requests associated with the first application thread;
identify a second trigger frequency associated with a second application thread, the second trigger frequency corresponding to second times of second requests associated with the second application thread, the second trigger frequency different from the first trigger frequency;
means for determining a third trigger frequency based on the first and second trigger frequencies; and
means for adjusting at least one of the first requests or the second requests to the third trigger frequency.

20. (canceled)

21. (canceled)

22. The apparatus of claim 19, wherein at least one of the first trigger frequency or the second trigger frequency is associated with an application setting, the application setting including at least one of measured preview latency, targeted preview latency, measured audio/video sync, or targeted audio/video sync.

23. The apparatus of claim 19, wherein the means for determining is to determine the third trigger frequency based on a minimum of the first trigger frequency and the second trigger frequency.

24. The apparatus of claim 19, wherein the means for determining is to determine the third trigger frequency based on a maximum of the first trigger frequency and the second trigger frequency.

25. The apparatus of claim 19, wherein the means for determining is to determine the third trigger frequency based on an average of the first trigger frequency and the second trigger frequency.

26. The apparatus of claim 19, wherein the means for adjusting is to adjust the at least one of the first requests or the second requests by delaying processing of the at least one of the first requests or the second requests.

27. The apparatus of claim 19, further including means for generating a notification, the notification to identify an adjustment of at least one of the first trigger frequency or the second trigger frequency.

28-36. (canceled)
